(19) United States
(12) Patent Application Publication
(10) Pub. No.: US 2009/0103606 A1
(43) Pub. Date: Apr. 23, 2009

(54) Progressive Distributed Video Coding

(75) Inventors: Yan Lu, Beijing (CN); Feng Wu, Beijing (CN); Shipeng Li, Redmond, WA (US); Mei Guo, Harbin (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/874,092

(22) Filed: Oct. 17, 2007

(51) Int. Cl. H04N 7/12

(52) U.S. Cl. 375/240.02

(57) ABSTRACT

Progressive distributed video coding is described. In one implementation, video data maybe encoded by arranging the data into bit-planes. The arrangement of bit-planes is adapted by shifting the first non-zero bit-plane left by one place in the binary digits and moving the sign bit immediately in the place vacated by the shifted non-zero bit-plane. The adapted bit-planes are then encoded using an asymmetric Slepian-Wolf encoder.

### BACKGROUND

With the increasing popularity of portable media devices there is a growing demand for real-time transmission of visual communications over wireless communications networks. Current video compression standards, such as MPEG, require the transmitting device's encoder to perform many more computations than the receiving device's decoder (e.g., the typical encoder is 5 to 10 times more complex than the decoder). This asymmetry is well-suited for broadcasting or streaming video applications where the visual communication is compressed once and decompressed many times. However, in applications such as wireless video surveillance and camera phones, this computational burden creates a bottleneck.

Distributed Video Coding (DVC) solves this problem by shifting the complex motion estimation and compensation from the encoder to the decoder. This allows portable devices with limited computational power and bandwidth to employ low complexity video encoding.

For example, a Wyner-Ziv (“W-Z”) video encoder compresses each video frame individually, requiring only intra frame processing, and then employs inter frame processing to decode the frames. Therefore, W-Z encoding has a great cost advantage over conventional encoding techniques since it compresses each video frame individually, requiring only intra frame processing, thereby shifting the complex motion estimation and compensation to the decoder.

Several practical Slepina-Wolf and Wyner-Ziv coding techniques have been proposed for distributed video coding. However, because some portable media devices have limited computational resources and/or bandwidth, such devices are not able to employ Wyner-Ziv encoding. Bit-plane representation provides a solution to achieving scalable Wyner-Ziv encoding where bandwidth is limited. However, conventional bit-plane representations have not work well in attempts to achieve scalable Wyner-Ziv encoding.

Thus, there is a need for scalable Wyner-Ziv encoding to enable portable media devices with limited processing power and/or bandwidth.

### SUMMARY

This summary is provided to introduce systems and methods for encoding visual communications, which are described in the Detailed Description. This summary is not intended to identify the essential features of the claimed subject matter, nor is it intended for determining the scope of the claimed subject matter.

In one implementation, video data is encoded by receiving video data from a data source. The video data is quantized by adaptively arranging the data into bit-planes. The arrangement of bit-planes is adapted by shifting the first non-zero bit-plane left by one place in the binary digits and inserting a sign bit in the place vacated by the shifted non-zero bit-plane. The adapted bit-planes are then encoded using an asymmetric Slepian-Wolf encoder.

In another implementation, a system for encoding video data includes a source of video data and a computing device. The computing device is configured to receive video data from the data source, adapt an arrangement of bit-planes by shifting the first non-zero bit-plane left by one place in the binary digits and inserting a sign bit in the place vacated by the shifted non-zero bitplane. The computer processor then encodes the adapted bit-planes using an asymmetric Slepian-Wolf encoder.

### BRIEF DESCRIPTION OF THE DRAWINGS

The teachings herein are described with reference to the accompanying figures. In the figures, the left-most reference number digit(s) identifies the figure in which the reference number first appears. The use of the same reference numbers in different figures indicates similar or identical items.

FIG. 1 depicts an illustrative wireless video data transmission network employing Wyner-Ziv encoding.

FIG. 2 depicts an illustrative Wyner-Ziv codec architecture.

FIG. 3 depicts an illustrative series of conventional bit-planes.

FIG. 4 depicts an illustrative bit-plane in accordance with an embodiment.

FIG. 5 depicts an illustrative bin representation for the B₀ bit-plane.

FIG. 6 depicts an illustrative bin representation for the B₀, B₁, and B₂ bit-planes in accordance with an embodiment.

FIG. 7 depicts an illustrative Wyner-Ziv architecture in accordance with an embodiment.

FIG. 8 is a block diagram illustrating a method for encoding data in accordance with an embodiment.

FIG. 9 is a block diagram illustrating a method for decoding data in accordance with a further embodiment.

### DETAILED DESCRIPTION

This disclosure describes progressive distributed video coding. Exemplary systems and methods adapt the bitplane's arrangement during encoding to enable scalable Wyner-Ziv (W-Z) video coding. In conventional video encoding techniques the sign bit constitutes the most significant bit-plane, by distinguishing positive from negative, for purposes of partitioning quantized data into bins. The exemplary systems described herein first determine a given coefficient's significance level (i.e., significant or non-significant), and then classify coefficients as positive or negative. For example, in a given binary codeword, the first non-zero bit-plane may be shifted one place to the left and the sign bit placed in the vacated position, instead of the conventional technique of always placing the sign in the most significant bit-plane (e.g., bit-plane B₀). This bitplane arrangement improves W-Z coding by correlating significant bit-planes more closely with the side information to achieve scalable W-Z video coding. The exemplary scalable W-Z video coding provides improved rate-distortion performance regardless of the bit-plane level being scaled to.

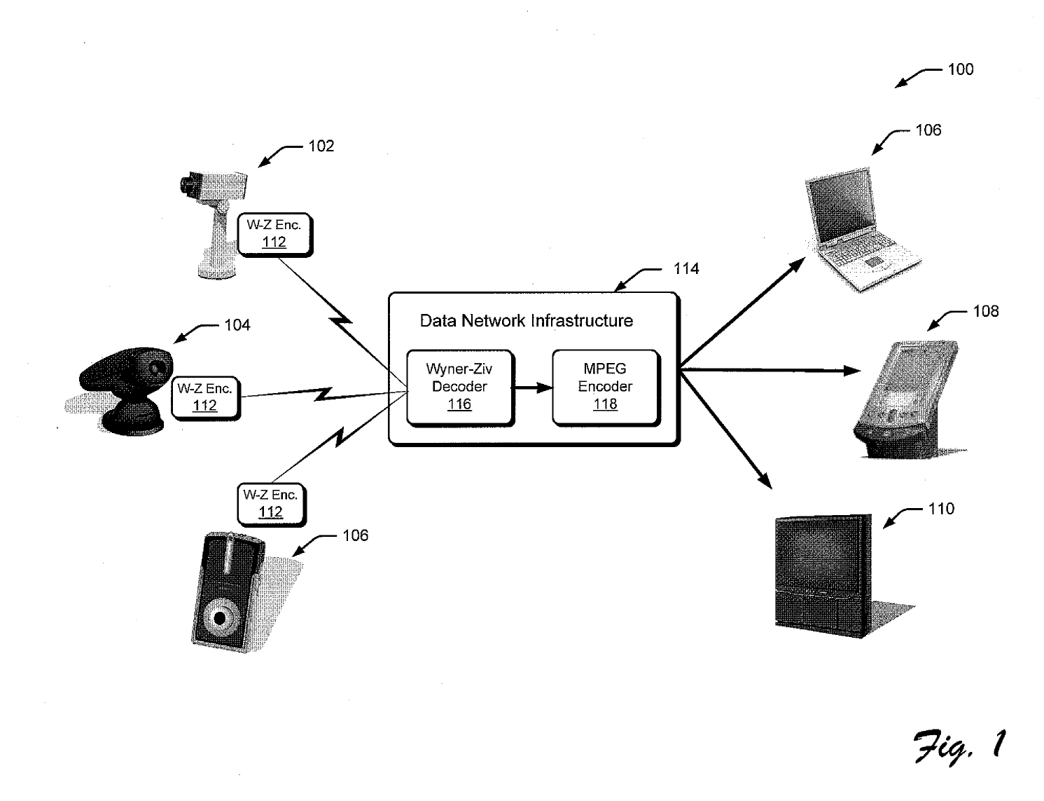

FIG. 1 depicts an illustrative video data transmission network employing Wyner-Ziv encoding 100. A wireless data network may be established between a wireless data source, such as a wireless video camera 102, a wireless sensor 104, or a camera phone 106, and a display device, such as a personal computer 106, personal digital assistant 108, or a television 110. The wireless device (e.g., 102-106) captures and compresses video data using an exemplary Wyner-Ziv (“W-Z”) encoder 112 and transmits the video data to a data network infrastructure 114. Within the infrastructure 114, a Wyner-Ziv decoder 116 decodes the bit stream, and a conventional encoder 118 (e.g., MPEG or JPEG) re-encodes the data for transmission to one or more display devices (e.g., 106-110). The display device(s) 106-110 then decodes the bit stream using conventional video decoding.

The illustrative video data transmission network 100 shifts the complex motion estimation and compensation from the wireless devices 102-106 to the data network's infrastructure 114, thus reducing the number of computations performed by the wireless devices 102-106 and greatly simplifying their design. This shift is made possible by the exemplary W-Z encoder, which lacks a prediction loop for motion estimation, and shifts the prediction burden to the exemplary W-Z decoder 116. The W-Z encoder 112 includes an exemplary bit-plane optimizer that allows the W-Z encoder 112 to be employed by devices 102-106 with limited processing power and/or limited bandwidth.

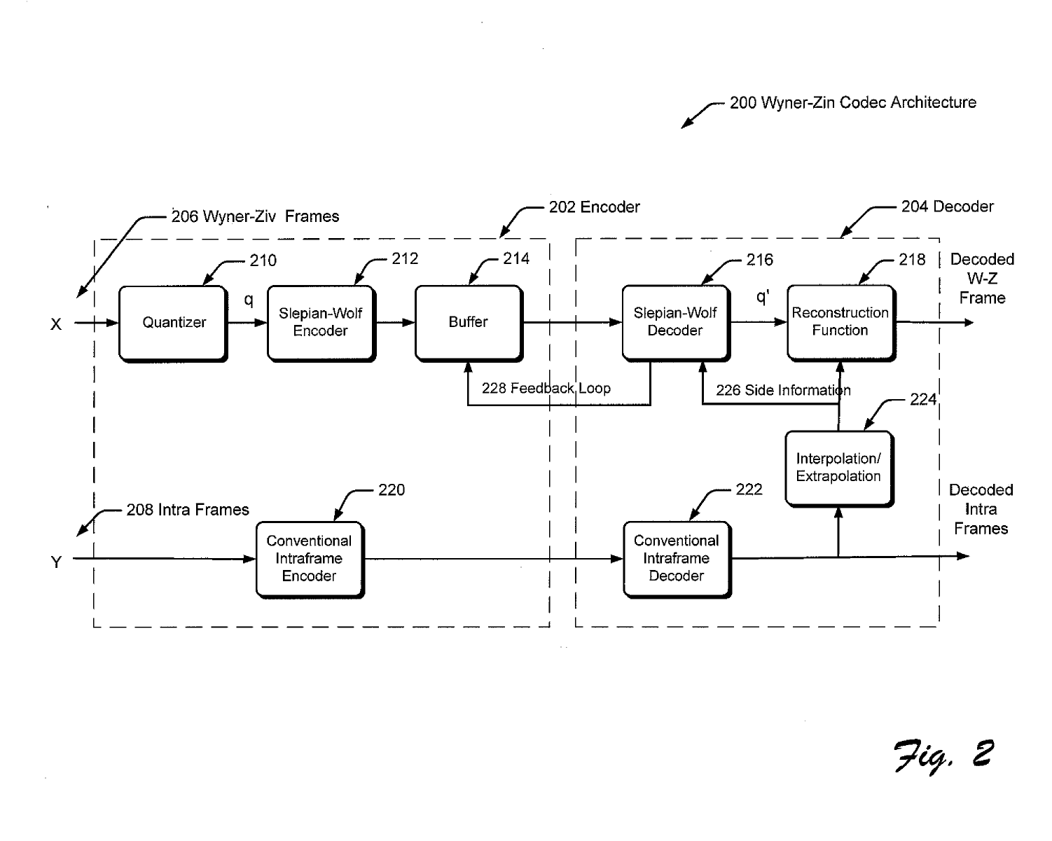

FIG. 2 illustrates a Wyner-Ziv codec architecture 200 for encoding 202 and decoding 204 video data. The video frames are organized into Wyner-Ziv frames 206 (W-Z frames) “X” and intra frames 208 “Y”, which are statistically correlated. The W-Z frames 206 are intraframe encoded, but are then interframe decoded using the side information 226. The intra frames 208 are spaced regularly in the sequence and are encoded 220 and decoded 222 using a conventional intraframe 8×8 Discrete Cosine Transform (DCT) codec.

The W-Z frames 208 are uniformly quantized using a 2^{M} level uniform scalar quantizer 210. The quantizer 210 divides the video data stream into cells, which may consist of non-contiguous sub cells, and provides the cells to a buffer (not shown). A block of quantized data “q” is then provided to the Slepian-Wolf encoder 212 which employs a Rate Compatible Punctured Turbo code (RCPT). The RCPT code provides the rate flexibility needed to adapt to the changing statistics between the side information 226 and the frame being encoded. The encoded W-Z frames 206 are then stored in a buffer 214 for transmission to the decoder 204.

The Slepian-Wolf decoder 216 generates the side information 226 by interpolation or extrapolation 224 of the decoded intra frames 208. The Slepian-Wolf decoder 216 assumes a Laplacian distribution for the difference between the W-Z frames 206 and side information 226 and estimates the Laplacian parameter by observing the statistics from the previously decoded frames.

The Slepian-Wolf decoder 216 then combines the side information 226 and the received parity bits to recover the quantizer index “q′”. If the Slepian-Wolf decoder 216 cannot reliably decode the data, it may request additional parity bits from the buffer 214 via a feedback loop 228. Additional bits are requested until an acceptable probability of data error has been reached.

Once the quantizer index q′ has been decoded, the reconstruction function 218 calculates a minimum-mean-squared-error reconstruction of the original W-Z frames 206. If the side information 226 is within the reconstructed bin, the estimation is accurate and the reconstructed pixel takes a value close to the side value. However, if the side information 226 and decoded quantizer index q′ are outside the quantization bin, the reconstruction function 218 forces the side information 226 to lie within the bin, thereby limiting the magnitude of the reconstruction error to a maximum value determined by the quantizer 210 coarseness.

As noted, the limited computational resources and/or bandwidth limitations of current wireless devices (102-106) may interrupt the W-Z encoding process and corresponding bit stream. Moreover, traditional bit-plane representations used in hybrid video coding do not work well in W-Z video coding. Rebollo-Monedero, Zang and Girod in “Design of Optimal Quantizers for Distributed Source Coding” (IEEE Data Compression Conference, Snowbird, Utah, March 2003) showed that the quantization in W-Z coding may not be identical to traditional joint coding (e.g., MPEG).

To solve these problems, we optimize the arrangement of the bit-planes during encoding of the video frames to provide scalable W-Z video coding. The bit-planes are adaptively produced according to the distribution of the source and the conditional distribution of the source given the side information 226. For discrete cosine transform (DCT) domain W-Z video coding, since the distributions of the DCT coefficients can be modeled as a Laplacian distribution, a simplified adaptive bit-plane representation is proposed. Based on the simplified adaptive bit-plane representation, a scalable W-Z video coding scheme is proposed in which the encoding and bit stream can be truncated according to the wireless device's (102-106) available computational resources and/or bandwidth.

Simplified Adaptive Bit-plane Representation

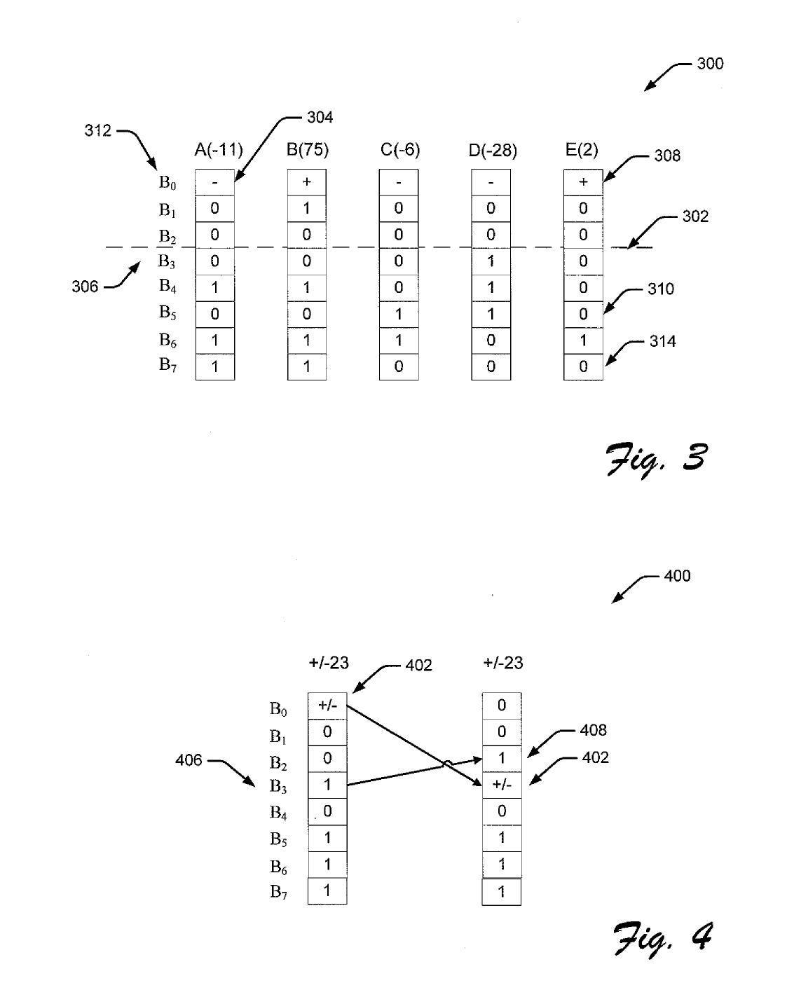

In bit-plane based conventional video coding, the residue between the source and the side information is directly entropy encoded by putting the sign bit immediately before the first significant bit. For example, referring to FIG. 3, if encoding is stopped or the bit-stream is interrupted at a certain bit-plane, for example B₂ 302, the negative sign bit of A(−11) 304 will be put at B₃ 306 and the positive sign bit of E(2) 308 will be put at B₅ 310. However, in Distributed Video Coding (DVC) the decoder does not know whether a certain bit-plane is a sign bit or a data bit. Thus without special processing, the sign bits may not be put at the most significant bit-planes.

FIG. 3 illustrates a conventional bitplane representation 300 of a discrete cosine transform (DCT) coefficient. For an 8-bit data representation there are 8 bit-planes 312 (e.g., B₀ through B₇). The first bit-plane “B₀” 304 contains the most significant bits and the eighth bit-plane B₇ 314 contains the least significant bits. The first bit plane 304, which defines the bit's sign (e.g., positive or negative), and gives the roughest but the most critical approximation of the bits value. For example, in PCM sound encoding the first bit in the sample denotes the sign of the function (e.g., amplitude value of the range) and the last bit defines the precise amplitude value. Changing the amplitude bit (e.g., from positive to negative) results in more distortion than changing the bits numeric value.

For purposes of illustration, we analyze the rate penalty in terms of the sign bit B₀ 304. When all the bitplanes 312 are encoded and transmitted the rate distortion changes very little compared with non-scalable coding. However, when the encoding is stopped or the bit-steam is interrupted at a bit-plane (e.g., B₂ 302), the sign bits B₀ 304 are not transmitted and the data is distorted. In contrast, when the encoding is stopped or the transmission interrupted and the corresponding bits are zero (e.g., coefficients A, C, D and E of bit-plane B₂ 302), the sign bits 304 contribute little to the rate distortion.

This example shows that truncation of conventional bit-plane representations can cause rate distortions in scaleable W-Z coding. The bit-plane representation divides the range of the source data from 2 to 2^{k} bins when 2^{k} level uniform pre-quantization is adopted. At each bit-plane level (e.g., B₀ through B₇) the source is partitioned into uniform bins. The size of the bin decreases from the most significant bitplane (e.g., B₀ 308) to the least significant one (e.g., B₇ 314). Moreover, the bin achieved at a certain bit-plane Bₜ₋₁ will be half of the next bit-plane Bₜ. However, in Distributed Video Coding (DVC) it is unnecessary to make the bins cover a continuous range because the final reconstruction is determined by the side information. Thus, the bit-plane representation should be optimized for source quantization.

In asymmetric W-Z coding the decoder 204 estimates the quantized source X, based on the side information Y, and their mutual correlation. In other words, the rate is determined by the probability that X and Y are located in the same bin. If Y is located in the same bin as X, the estimation is accurate and no additional W-Z bits are required. However, if X and Y are in different bins, additional W-Z bits are required to correct the errors at the decoder. If X is quantized into N Bins: {[a₀, a₁-1], [a₁, a₂-1], . . . [aₙ₋₁, aₙ-1], and P(x,y) denotes the joint probability of X and Y being in the same bin. Then the lowest bit rate can be achieved by maximizing:

$$Ψ = {\sum }_{i = 0}^{N - 1} {\int }_{{a}_{i}}^{{a}_{i + 1}} {\int }_{{a}_{i}}^{{a}_{i + 1}} P ( x , y ) d x d y$$

Therefore, irregardless of the source X and side information Y, an optimum quantization method can be derived from their joint distribution.

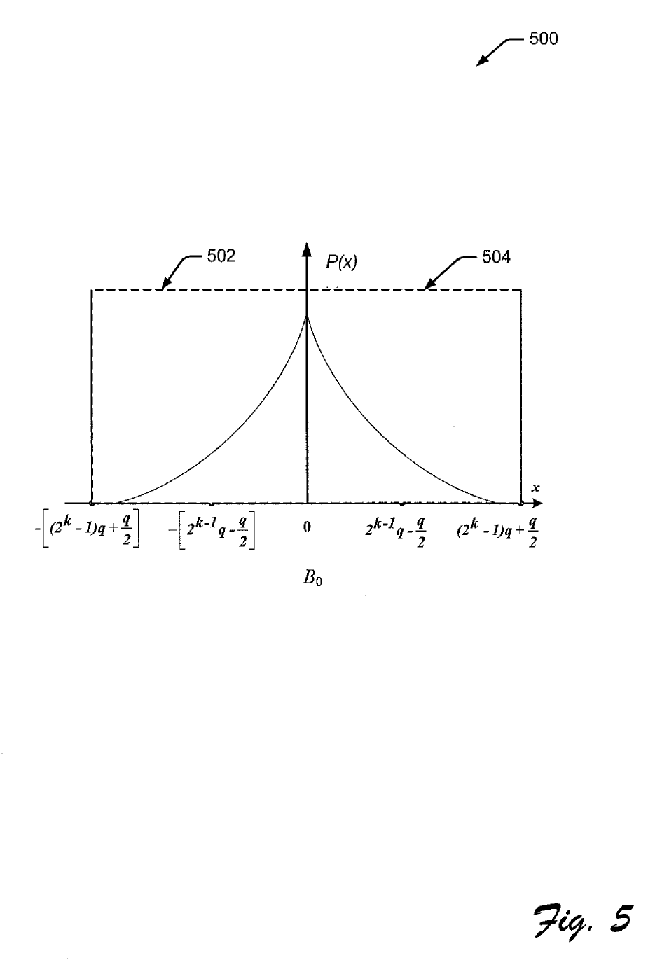

Since the discrete cosine transformation (DCT) coefficients generally have a zero-mean Gaussian or Laplacian distribution, we propose an adaptive bit-plane representation in terms of the sign bits (e.g., B₀ 304). FIG. 4 depicts an illustrative adaptive bit-plane representation 400 with optimal quantization for DCT domain W-Z video coding.

In our adaptive bit-plane representation 400 the sign bit 402 is placed in the most significant bit-plane. For example, the first non-zero bit-plane (e.g., B₃ 406) is shifted up by one digit (e.g., B₂ 408), and the sign bit 402 is inserted immediately after the first non-zero bit (e.g., B₂ 408).

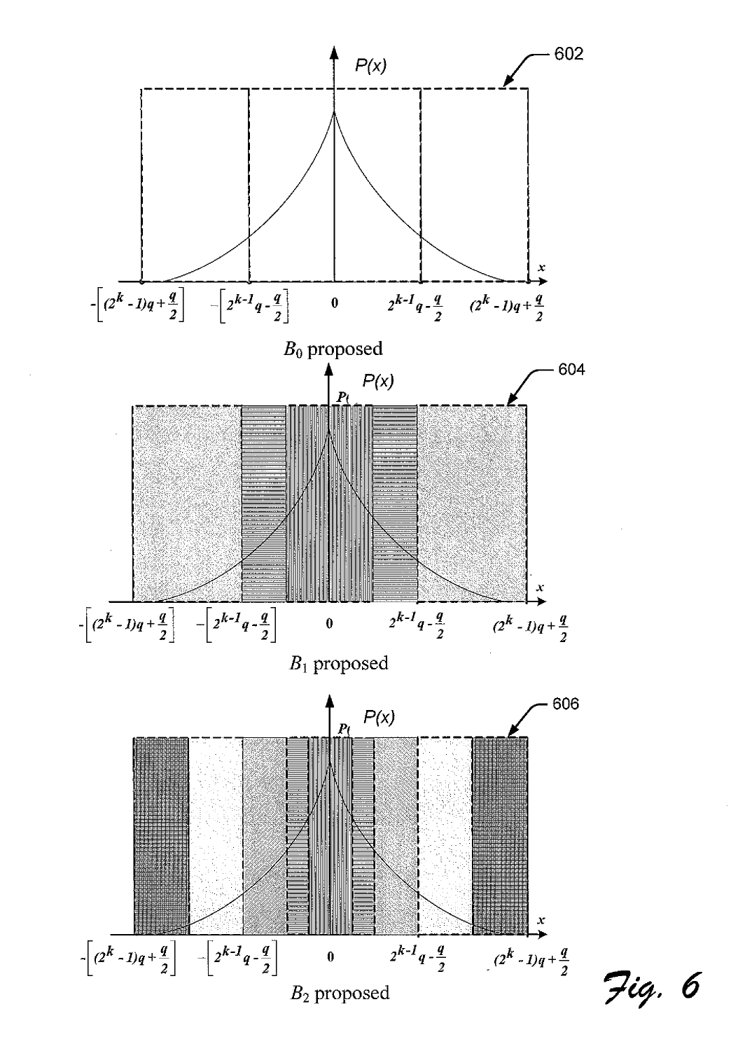

FIG. 5 shows an illustrative bin representation 500 at each bit-plane for a conventional bit-plane approach. From the most significant bit-plane (e.g., B₀ 304) to the least significant one (e.g., B₇ 314), the source signal X is partitioned from the coarse bins to the fine bins. Each bit-plane divides the bins associated with the previous bit-plane in half. The Slepian-Wolf decoder 216 then estimates the bins that the coefficients belong to based on the side information 226. In a conventional bit-plane approach, the sign bit 402 is placed in the most significant bit-plane. Thus, the source signal is first partitioned between the positive bin 502 and negative bin 504. The Slepian-Wolf decoder 206 then estimates whether the current coefficient is positive or negative.

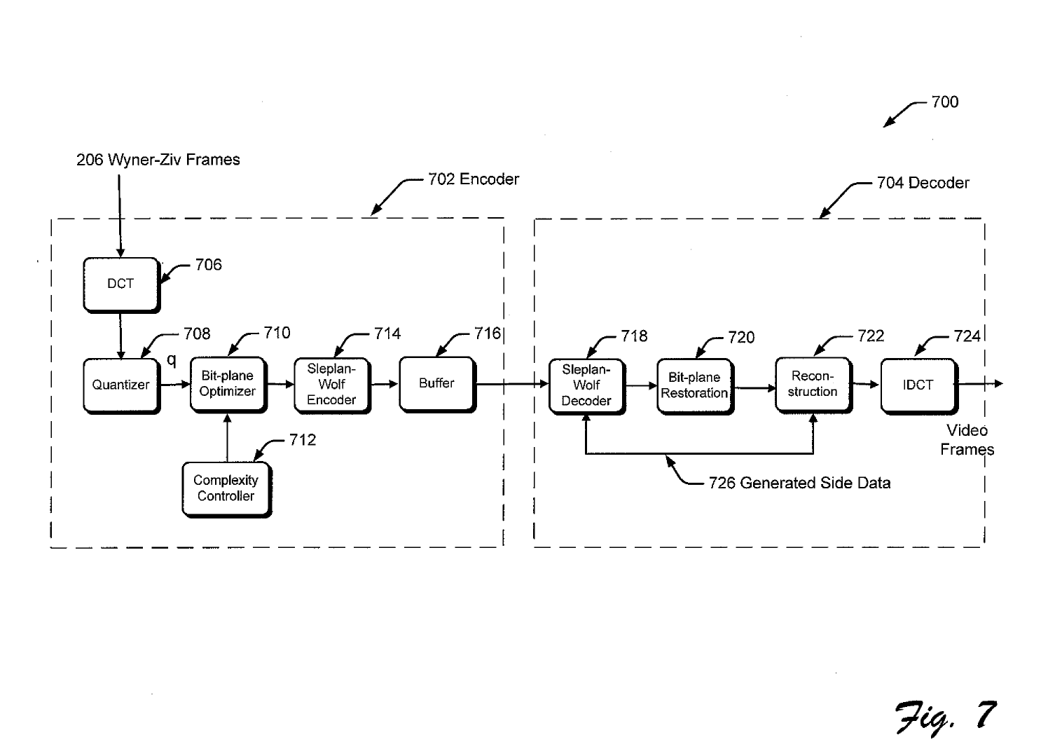

FIG. 6 depicts a series of illustrative bin representations 602-606 for the proposed adaptive bit-plane representation. As illustrated, each bit-plane divides the bins associated with the previous bit-plane in half. (e.g., bins B₀ 602 and B, 604 are partitioned into 4 and 8 bins respectfully). This results in the most significant bit-planes being divided into course bins 602 (e.g., B₀ is portioned into 4 bins) and the least significant bit-planes being divided into fine bins 606 (e.g., B₂ is portioned into 16 bins).

During encoding, a bit-plane optimizer adaptively arranges the bit-planes (as illustrated in FIG. 4), so that their bins are partition as depicted in FIG. 6. Then during decryption, the Slepian-Wolf decoder 216 estimates the bin that the bit-plane coefficient should belong based on the side information 226. The decoder 216 then uses the transmitted W-Z bits to correct this estimation. The more accurate this estimation is, the fewer bits that are needed. Thus, the method in which the bins are partitioned influences the coding efficiency.

Scalable Wyner-Ziv video coding framework

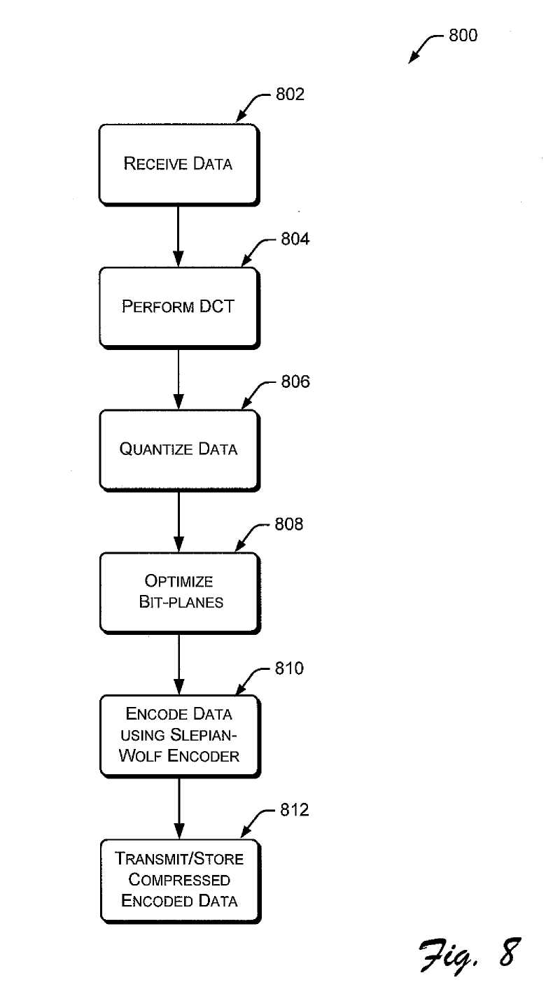

Having described the adaptive bit-plane representation 400 with optimal quantization for W-Z video coding, the discussion now shifts to the scaleable W-Z video coding architecture. FIG. 7 depicts an illustrative scaleable W-Z video coding architecture 700 according to an embodiment. The encoder 702 receives W-Z frames 206 from a video data source (e.g., 102-106) and performs a 4×4 discrete cosine transform (DCT) 706 on each frame.

A quantizer 708 then adaptively arranges the coefficients (e.g., −11, 75, −6, etc.) into bitplanes (e.g., B₀, B₁, B₃, . . . Bₖ₋₁), as depicted in FIG. 3. The sign bit 304 is put in the most significant bit-plane.

A bit-plane optimizer 710 then optimizes the bit-plane design by shifting the first non-zero bitplane 404 up by one digit and inserting the sign bit 402 in the place vacated by the shifted non-zero bit-plane.

The bit-planes are then provided to a Slepian-Wolf turbo encoder 714 for compression. The complexity controller 712 informs the Slepian-Wolf encoder 714 whether encoding of the current bit-plane can be completed with the wireless device's (102-106) available computational resources and/or bandwidth. If the remaining computational resources are not enough to finish encoding the current bit-plane or the available bandwidth is not enough to transmit more bits, the complexity controller 712 commands the Slepian-Wolf turbo encoder 714 to stop encoding. The encoded bitplanes may optionally be stored in a buffer 716 for later decoding.

The decoder 704, receives the encoded bit-planes from the buffer 716 and/or the Slepian-Wolf encoder 714 itself. A Slepian-Wolf decoder 718 reconstructs the quantized coefficient bands using generated side information 726. The side information 726 is generated by interpolating the adjacent reconstructed frames using symmetric motion estimation, followed by 4×4 DCT. The Slepian-Wolf decoder 718 then decodes the bit-planes based on posterior probability (PP). Given the possible value j equaling zero or one, PP is expressed as:

$$PP = {\sum }_{{χ}_{j}} {α}_{i - 1} ( {s}^{′} ) {γ}_{i} ( {s}^{′} , s ) {β}_{i} ( s )$$

Where χⱼ is the set of all transitions from state s′ to s with the input j. The probability functions αᵢ(s) and βᵢ(S) can be recursively calculated from the probability γᵢ(s′, s). Given one bit-plane, the decoding exploits the correlations with both side information 726 and the previously decoded bit-planes.

For decoding Bᵢ, the transitional probability is represented as:

γᵢ(s′,s)=P(j)P(j∥yᵢ,B₀,B₁, . . . , Bₜ₋₁)P(uᵢ∥pᵢ)

Where uᵢ is the output parity bit of the transition from state s′ to s with the input j, yᵢ and pᵢ representing the corresponding side information 726 and the received parity bit. The conditional probability P(j∥yᵢ, B₀, B₁, . . . , Bₜ₋₁) can be calculated as the probability of the difference between the estimated coefficient and the side information 726. The estimate of the current coefficient is chosen from the bin. It should be noted that the assignment of the partitioned bins at a certain bit-plane level relies on the bit-plane arrangement.

The bit-plane restoration function 720 then receives the decoded bit-planes from the Slepian-Wolf decoder 718. The bit-planes are restored by removing the sign bit from the decoded symbol and placing it at the most significant bit-plane (e.g., the inverse of the process illustrated in FIG. 4).

The restored bit-planes are then reconstructed 722 as the best estimate given the reconstructed symbols and side information 726. The reconstruction function 722 is calculated to minimize the distortion between the W-Z frames 206 and the reconstructed frames. If the side information 726 is located within the bin indicated by the restored symbol, the reconstructed value will take the corresponding side information value. If the side information 726 is outside the bin, the reconstruction function 722 will clip the reconstruction towards the boundary of the bin closest to the side information 726. Finally, an inverse discrete cosine transformation (IDCT) 724 is performed on each reconstructed bit-plane.

Having described the adaptive bitplane representation 400 with optimal quantization and the scaleable W-Z video coding architecture 700, the discussion now shifts to illustrative methods for encoding and decoding video data.

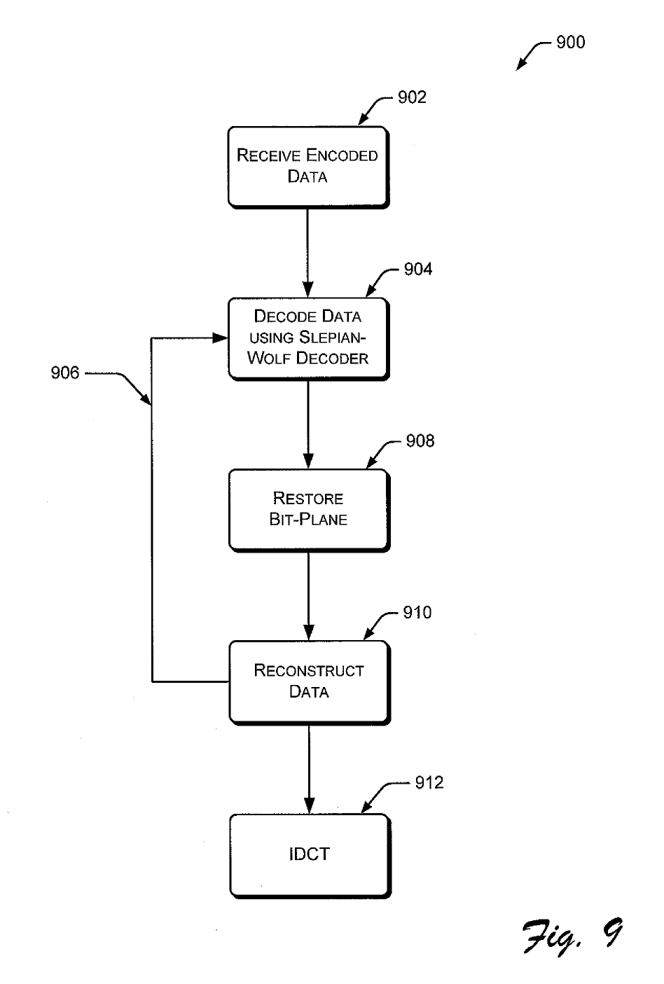

FIG. 8 depicts an illustrative method for encoding video data in accordance with an embodiment. Video data is received from a wireless device (e.g., 102-106), at block 802. The video data could be a continuous source or a discrete source of data. A continuous source generates data in a continuum. While a discrete source generates a finite amount of data. It should be appreciated that the wireless device (e.g., 102-106) may be a source of video data, image data, text data, graphical data, physical measurement data (e.g., physical sensor data), or any combination thereof.

A 4×4 discrete cosine transform (DCT) is performed on each frame, at block 804.

The quantizer 708 adaptively arranges the video data into bit-planes (e.g., B₀, B₁, B₃, . . . B_{N}), which may consist of non-contiguous sub cells mapped into the same quantizer index, at block 806. The W-Z frames 206 are uniformly quantized with 2m intervals and a sufficiently large quantity of quantizer indicies (q) are provided to the bitplane optimizer 710.

The quantized bit-planes (q) are then optimized by shifting the first non-zero bit-plane left by one digit and moving the sign bit immediately after the first non-zero bit, at block 808. The complexity controller 712 then detects the wireless device's (e.g., 102-106) available computational resources and bandwidth. If the computational resources are insufficient to finish encoding the current bit-plane, or the bandwidth is inadequate to transmit the optimized bits, the complexity controller 712 commands the Slepian-Wolf turbo encoder 714 to stop encoding.

The optimized bit-planes are then encoded using the asymmetric Slepian-Wolf encoder 714, at block 810. The Slepian-Wolf 714 encoder is implemented using a Rate Compatible Punctured Turbo code (RCPT). The RCPT provides the rate flexibility that is essential to adapting to the changing statistics between the generated side information 726 and the frames being encoded.

The encoded data maybe stored and/or transmitted, at block 812. In one embodiment, the encoded data is stored in a buffer and/or memory 716 for decoding at a later time. In an alternate embodiment, the encoded data is transmitted directly to a decoding device 704 for immediate decoding.

Having described illustrative methods for encoding data, the discussion now shifts to illustrative methods for decoding data. FIG. 9 depicts an illustrative method for decoding data in accordance with another embodiment. The encoded data is received by the decoder 704, at block 902. The encoded data is a compressed representation of a block of data from one or more wireless devices (e.g., 102-106)

An asymmetric Slepian-Wolf decoder 718, using the generated side information 726, generates a block of intermediate data, at block 904. As noted, the Slepian-Wolf decoder 718 decodes the bit-planes based on posterior probability (PP).

The bit-planes are then restored, at block 908. This is achieved by removing the sign bit from the decoded symbol and placing it at the most significant bit-plane (e.g., the inverse of the process illustrated in FIG. 4).

The restored bit-planes are then reconstructed as the best estimate given the reconstructed symbols and side information 726, at block 910. The reconstruction function is designed to minimize the distortion between the W-Z frames 206 and the reconstructed frames. If the side information 726 is located within the bin indicated by the restored symbol, the reconstructed value will take the corresponding side information value 726. If the side information 726 is outside the bin, the reconstruction function clips the reconstruction towards the boundary of the bin closest to the side information 726. The side information 726 is generated by interpolating the adjacent reconstructed frames with symmetric motion estimation.

An inverse discrete cosine transform is then preformed, at block 912.

### Conclusion

Although the subject matter has been described in language specific to certain features and/or methodical acts, it is to be understood that the subject matter defined in the appended claims is not limited to the specific features or acts described above. Rather the specific features and acts described above are disclosed as example forms of implementing the claimed subject matter.

What is claimed is:

1. A method for encoding video data, the method comprising:
receiving video data from a video data source; and
adapting an arrangement of bit-planes during encoding of the video data to provide scalable Wyner-Ziv video coding.

2. The method of claim 1, wherein adapting an arrangement of bit-planes comprises placing a significant bit in a more significant bit-plane to enhance a correlation between the bit-planes and side information during Wyner-Ziv video coding.

3. The method of claim 2, wherein placing a significant bit in a more significant bit-plane comprises shifting the first non-zero bit up by one digit and moving a sign bit immediately after the non-zero bit.

4. The method of claim 1, further comprising:
applying a discrete cosine transform (DCT) to the video data;
quantizing the video data by adaptively arranging the video data into bit-planes; and
optimizing the bit-planes by modifying their partitions such that more significant bit-planes are divided into course bins and least significant bit-planes are divided into fine bins.

5. The method of claim 4, further comprising:
encoding the bit-planes by applying an asymmetric Slepian-Wolf encoder.

6. The method of claim 5, further comprising:
monitoring one or more of the video data source's computational resources or bandwidth; and
instructing the asymmetric Slepian-Wolf encoder to stop compressing the current bit-plane if the video data source's computational resources or bandwidth are inadequate.

7. The method of claim 4, wherein the video data is quantized using a 2^{m} level uniform scalar quantizer.

8. The method of claim 5, further comprising:
buffering the encoded bit-planes for later decoding.

9. A method for decoding video data, the method comprising:
receiving encoded video data;
decoding the encoded video data by applying an asymmetric Slepian-Wolf decoder, the Slepian-Wolf decoder decodes bit-planes based on generated side information; and
reconstructing the bit-planes by removing a sign bit from a decoded bit-plane and placing the sign bit at a more significant bit-plane.

10. The method of claim 9, wherein the encoded video data is received from a buffer.

11. The method of claim 9, wherein the side information is generated by interpolating adjacent reconstructed frames using symmetric motion estimation.

12. The method of claim 9, further comprising performing an inverse discrete cosine transformation on the reconstructed bit-planes.

13. A system for encoding video data, the system comprising:
a computing device configured to:
receive video data from a video data source; and
adapt an arrangement of bit-planes during encoding of the video data to provide scalable Wyner-Ziv video coding.

14. The system of claim 13, wherein adapting an arrangement of bit-planes comprises placing a significant bit in a more significant bitplane to enhance a correlation between the bit-planes and side data during Wyner-Ziv video coding.

15. The system of claim 14, wherein placing a significant bit in a more significant bit-plane comprises shifting the first non-zero bit up by one digit and inserting a sign bit immediately after the non-zero bit.

16. The system of claim 13, wherein the computing device is further configured to:
apply a discrete cosine transform (DCT) to the video data;
quantize the video data by adaptively arranging the video data into bit-planes; and
optimize the bit-planes by modifying their partitions such that more significant bit-planes are divided into course bins and least significant bit-planes are divided into fine bins.

17. The system of claim 16, wherein the DCT coded data is quantized using a 2^{m} level uniform scalar quantizer.

18. The system of claim 13, wherein the computing device is further configured to encode the bit-planes by applying an asymmetric Slepian-Wolf encoder.

19. The system of claim 17, wherein the computing device is further configured to:
monitor one or more of the video data source's computational resources or bandwidth; and
instruct the asymmetric Slepian-Wolf encoder to stop encoding the current bit-plane if the video data source's computational resources or bandwidth are inadequate.

20. The system of claim 17, wherein the computing device is further configured to buffer the encoded bit-planes for later decoding.
